(19) United States
(12) Patent Application Publication
(10) Pub. No.: US 2004/0010498 A1
(43) Pub. Date: Jan. 15, 2004

(54) Object persistence to relational database within run-time environment supporting attributes and reflection

(76) Inventor: Tser Yeng Lin, Torrance, CA (US)

Correspondence Address: LAW OFFICES OF MICHAEL DRYJA, 704 228TH AVENUE NE, PMB 694, SAMMAMISH, WA, 98074, US

(21) Appl. No.: 10/064,394

(22) Filed: Jul. 10, 2002

(51) Int. Cl. G06F 7/00

(52) U.S. Cl. 707/100; 707/104.1

(57) ABSTRACT

Object persistence to a relational database, within a run-time environment that has reflection and attribute properties, is disclosed. The invention can be implemented within a software module or library that contains a persistent base class that includes persistence functionality relative to a relational database. A software object class is derived from the persistence base class. The software object class inherits the persistence functionality from the persistence base class. A developer can add appropriate persistence attributes to the software object class source code. The software object class is then compiled to an executable form that has the persistence functionality built-in. The executable software object is thus able to persist to the relational database using this methodology.

### BACKGROUND OF INVENTION

This invention relates generally to object-oriented software objects, and more particularly to persisting such objects within relational database management systems (RDBMS).

Object-oriented technology in conjunction with software can be generally defined as the use of objects as the building blocks for applications. Objects are independent program modules written in object-oriented programming languages. Just as hardware components are routinely designed as modules to plug into and work with each other, objects are software components designed to work together at runtime without any prior linking or precompilation as a group.

In object-oriented application development, it is often desirable to store an object's current state into a permanent storage medium. Persistence may be needed to free up software and hardware resources used by such an object, when the object is no longer currently being used. When the object is later needed, it may then be retrieved from the permanent storage medium. The storage of objects into a permanent storage medium is generally referred to as persistence.

One type of permanent storage medium that is well known, and therefore has been looked to for object persistence, is a relational database management system (RDBMS). A relational database links files together as required. Relationships between files are created by comparing data, such as account numbers and names. A relational system has the flexibility to take any two or more files and generate a new file from the records that meet the matching criteria.

Relational databases are an example of non-object-oriented data stores. As such, they organize and store data differently than do object-oriented paradigms, such as software objects. Relational databases are thus inherently incapable of communicating with software objects in object-oriented terms, and are not immediately amenable as a permanent storage medium for the persistence of software objects. This is unfortunate, since relational databases represent established and known technology.

Current approaches to allow software objects to persist to relational databases and other types of non-object-oriented data stores have focused on external bridging mechanisms that enable software objects to communicate with such data stores. However, even when these mechanisms are available, they can require significant programming effort on the part of developers to make their software objects persistent using a non-object-oriented data store. The additional complexity of the mechanisms may become burdensome to the developers.

For example, a software object may first have to establish a communication channel with a non-object-oriented data store through an external bridging mechanism. The object may then have to translate object states and relationships into commands and/or languages, such as the Structure Query Language (SQL), understandable by the non-object-oriented data store. Finally, the object may have to issue such commands and/or languages to the non-object-oriented database to achieve the desired persistence functionality.

Therefore, the presence of an external bridging mechanism is no panacea to the average developer of software objects using object-oriented technology. The developer must still have an understanding of how the non-object-oriented data store works, and must still manually code his or her software objects so that they can persist to such data stores using an external bridging mechanism. For these and other reasons, therefore, there is a need for the present invention.

### SUMMARY OF INVENTION

The invention relates to object persistence to a relational database, within a runtime environment that has reflection and attribute properties. The reflection property enables discovery of persistence attributes embedded within domain object classes of applications. The invention can be implemented within a software module or library that contains a persistent base class that includes persistence functionality relative to a relational database. A software object class is derived from the persistence base class. The software object class inherits the persistence functionality from the persistence base class. A developer can add appropriate persistence attributes to the software object class source code. The software object class is then compiled to an executable form that has the persistence functionality built-in. The executable software object is thus able to persist to the relational database using this methodology.

Embodiments of the invention provide for advantages over the prior art. An external bridging mechanism between the object-oriented software objects and the non-object-oriented data store, such as a relational database, is not needed. A developer can have his or her objects persist themselves to the data store, without having to know how to translate object states and relationships into commands and/or languages understandable by the data store. Development of software objects that persist themselves to data stores is thus made simpler and more efficient. Still other advantages, aspects, and embodiments of the invention will become apparent by reading the detailed description that follows, and by referencing the accompanying drawings.

### BRIEF DESCRIPTION OF DRAWINGS

The drawings referenced herein form a part of the specification. Features shown in the drawings are meant as illustrative of only some embodiments of the invention, and not of all embodiments of the invention, unless otherwise explicitly indicated, and implications to the contrary are otherwise not to be made.

FIG. 1 is a diagram of a run-time environment according to a preferred embodiment of the invention.

FIG. 2 is a flowchart of a method that is more detailed than but consistent with the method of FIG. 1, according to an embodiment of the invention.

FIG. 3 is a diagram of a detailed example, in conjunction with which the method of FIG. 2 is illustratively described but to which the method of FIG. 2 is not limited, according to an embodiment of the invention.

FIG. 4 is a diagram showing an example of how the objects of the object-oriented model resulting from performing the method of FIG. 2, an example of the performance of which is shown in FIG. 3, maps and persists to tables of a relational database, according to an embodiment of the invention.

FIG. 5 is a diagram showing an example of how the objects of the object-oriented model of FIG. 4 are hierarchically related to the persistent base software object class to obtain persistent functionality, according to an embodiment of the invention.

FIG. 6 is a diagram showing an example of software code that can utilize domain object classes having persistence functionality built-in, according to an embodiment of the invention.

### DETAILED DESCRIPTION

In the following detailed description of exemplary embodiments of the invention, reference is made to the accompanying drawings that form a part hereof, and in which is shown by way of illustration how specific embodiments of the invention may be practiced. These embodiments are described in sufficient detail to enable those skilled in the art to practice them. Other embodiments may be utilized, and logical, mechanical, and other changes may be made without departing from the spirit or scope of the present invention. The following detailed description is, therefore, not to be taken in a limiting sense, and the scope of the invention is defined only by the appended claims.

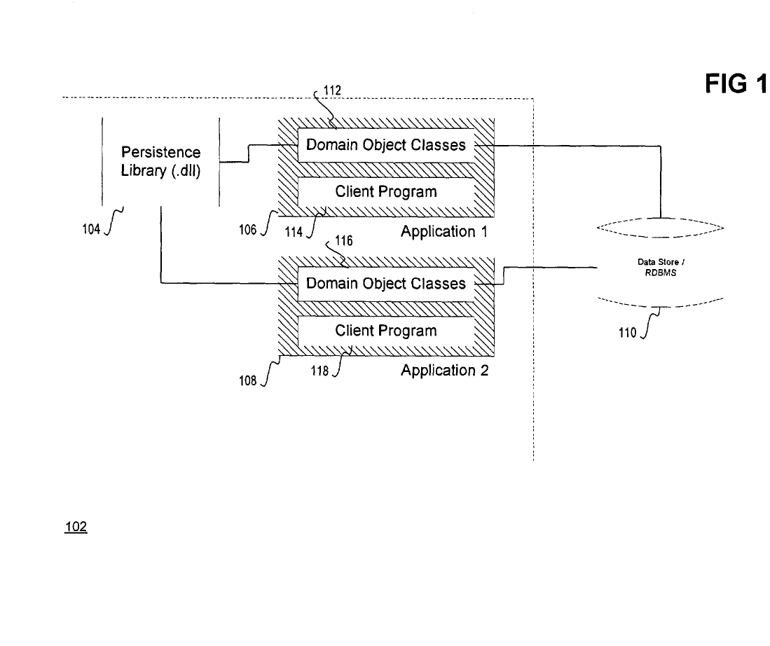

FIG. 1 shows a run-time environment 102 according to a preferred embodiment of the invention. The environment 102 preferably supports attributes and reflection, such as the Microsoft NET environment, available from Microsoft Corp., of Redmond, Wash. Attributes are keyword-like descriptive declarations, called attributes, which annotate programming elements, such as types, fields, methods, properties, and so on. Attributes may be saved within the meta data of a Microsoft NET framework file, and can be used by developers to describe software code to the run-time environment, or to affect application behavior at run-time. The reflection feature allows the environment 102 to discover, or retrieve, attribute or type information.

The environment has a persistence library 104, and two example application programs 106 and 108. The persistence library 104 is preferably a dynamically linked library (DLL) file. The persistence library 104 has core classes including a persistence base class, a persistence object collection class, and persistence attribute classes. The persistence base class may be referred to as DBObj, whereas the persistence object collection class may be referred to as DBObjCollection. The persistence attribute classes can include PersistenceClassAttribute, PersistenceFieldAttribute, PersistenceObjAttribute, and PersistenceObjCollectionAttribute.

The persistence base class includes the structure and the methods to be inherited by derived classes to perform persistence functions on instances of the derived classes. The persistence object collection class i.e., the persistence object class is a specialized class, to hold a group of instances of a persistence base derived type. The persistence attribute classes are various attribute types that developers can use to add persistence information to their own domain object classes. The domain object classes typically represent business entities that need persistent storage, and client programs that contain the application logic to manipulate instances of the domain object classes. For example, such business entities may include order forms, customers, order items, and so on.

The application programs 106 and 108 thus include client programs 114 and 118, respectively, and domain object classes 112 and 116, respectively. The domain object classes 112 and 116 inherit persistence functionality from the persistence library 104, and instances thereof are persisted using this functionality to the relational database management system (RDBMS) 110. The client programs 114 and 118 therefore include the application logic of the application programs 106 and 108 to manipulate instances of the domain object classes 112 and 116, which are retrieved from and saved to the RDBMS 110.

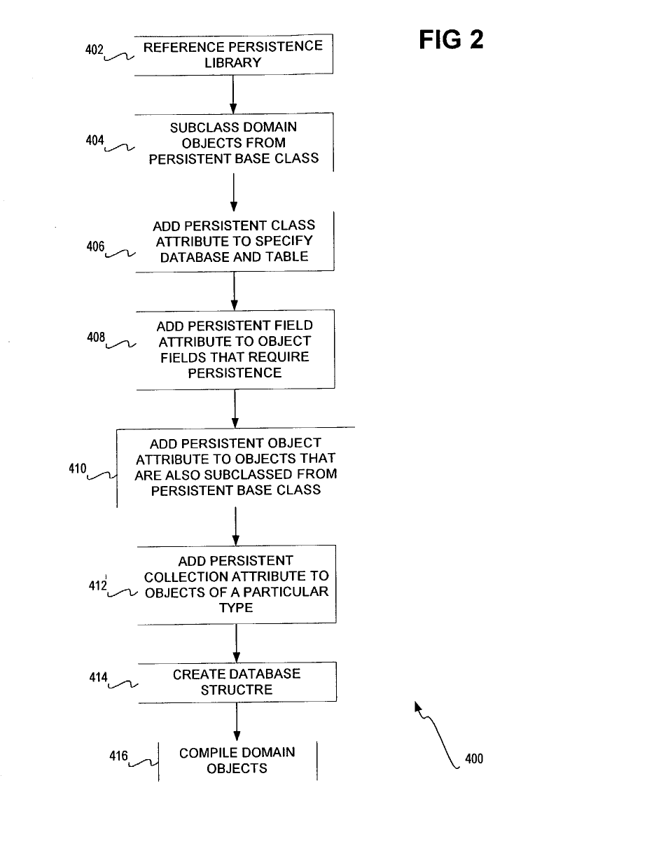

FIG. 2 shows a method 400 according to an embodiment of the invention, which can be used in conjunction with the environment 102 of FIG. 1. At least some parts of the method 400 can be implemented as a computer program stored on a computer-readable medium. The computer-readable medium may be a volatile or a nonvolatile storage medium, as well as a removable or a fixed medium. The medium can be a magnetic medium, such as a floppy disk or a hard disk drive, an optical medium, such as a CD-ROM, a semiconductor memory medium, or another type of medium. The program may include one or more software components, modules, subroutines, objects, and so on.

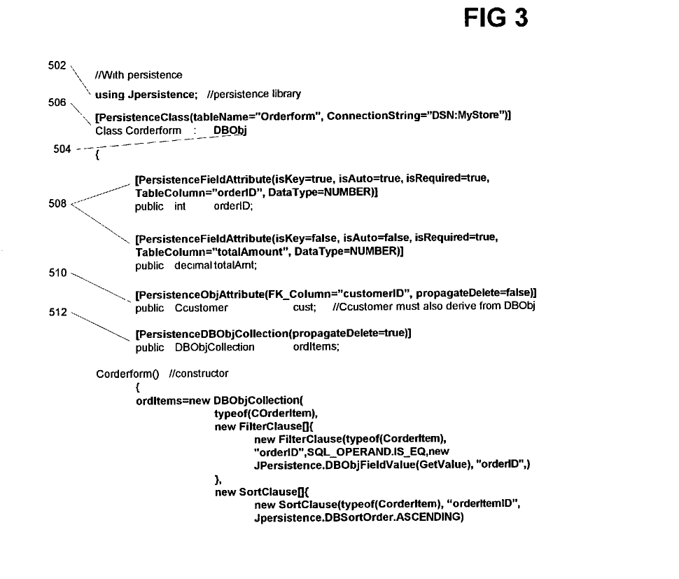

The method 400 is described in particular relation to the example of FIG. 3, for illustrative clarity. However, the method 400 is not limited to the example of FIG. 3. Similarly, other embodiments of the invention are not limited to the example of FIG. 3. FIG. 3 is specifically an example of a domain object class that includes built-in persistence functionality on account of being subclassed, or derived, from a persistence base class, and that can be compiled to yield one or more executable software objects.

The method 400 of FIG. 2 first references the persistence library (402), which is indicated in FIG. 3 with the reference number 502. The persistence library is the library 104 of FIG. 1. Thus, domain object classes are subclassed from the persistent base class to inherit the persistence functionality (404), as indicated in FIG. 3 with the reference number 504. Next, the persistent class attribute is added to specify the database and the table to which this type maps (406), as indicated in FIG. 3 by the reference number 506. In the example of FIG. 3, this is the persistence information for the class Corderform, specifying the corresponding table in the database that can be referenced by ConnectionString.

A persistent field attribute is added to object fields that require persistent (408), as indicated in FIG. 3 by the reference number 508. This is the persistence information for field-to-column mapping, specifying the table column to which to map. This information also specifies whether the field is a key field, whether the value is generated by the relational database when initially saved, and whether this field is required. A persistent object attribute is added to objects that are also subclassed from the persistent base class (410), as indicated in FIG. 3 by the reference number 510. This is the persistence information for field-to-object mapping. The information specifies the column in the current object's table used to fetch the key value used to retrieve a related object, Ccustomer. The information also specifies whether the related object will be deleted when the current object invokes its delete function.

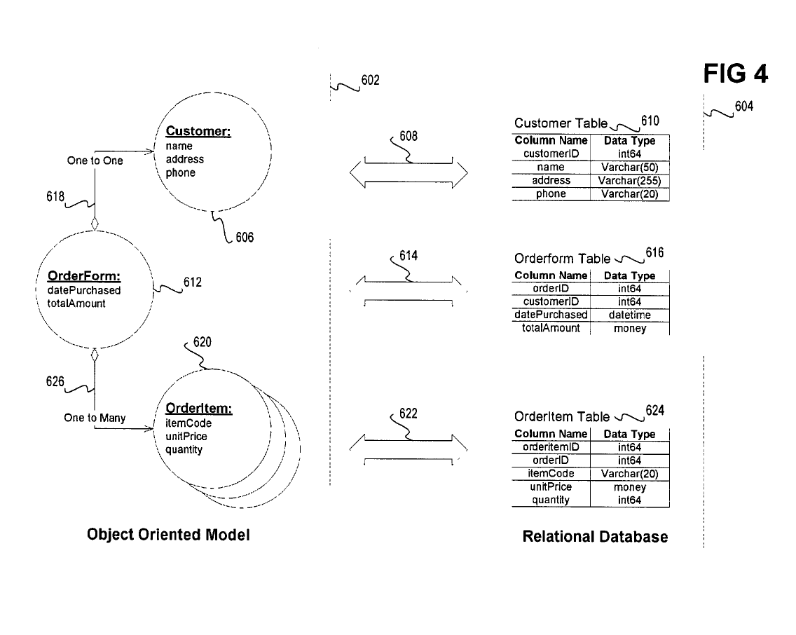

Next, a persistent collection attribute is added to objects of a particular type (412), which is indicated in FIG. 3 by the reference number 512. In the example of FIG. 3, objects that are of the type DBObjCollection have this attribute added thereto, where this type is a collection of objects that are of the same type that are derived from the persistent base class. Instantiation is needed in the constructor method of the containing class. The persistent collection attribute is thus persistence information for a collection of related objects of the same type, and specifies whether, in the example of FIG. 3, the orderitems related to the orderform will be deleted when the orderform is deleted. The class constructor in the example of FIG. 3 specifies the relationship “orderitems whose orderlD equals my orderlD, as well as the sort order.”The method 400 finally creates the database structure that serves as the persistence storage of domain objects (416). FIG. 4 shows the resulting object-oriented model 602 for the example of FIG. 3, and a corresponding relational database 604 to which the objects of the model can be persisted, according to an embodiment of the invention. The database 604 has a structure that is constructed in 414 of the method 400 of FIG. 2, for instance. The object model 602 includes the objects 606, 612, and 620, whereas the relational database 604 includes tables 61 0, 61 6, and 624.

The customer object 606 is mapped and persisted to the customer table 610, as indicated by the bi-directional arrow 608. Similarly, the orderform object 612 is mapped and persisted to the orderform table 616, as indicated by the bi-directional arrow 614, and the orderitem object 620 is mapped and persisted to the orderitem table 624, as indicated by the bi-directional arrow 622. The relationship between the orderform domain object 612 and the customer domain object 606 is one to one, as indicated by the arrow 618, whereas the relationship between the orderform domain object 612 and the orderitem domain object 620 is one to many, as indicated by the arrow 620. That is, for each order form there is only one customer, whereas there can be more than one order item within each order form.

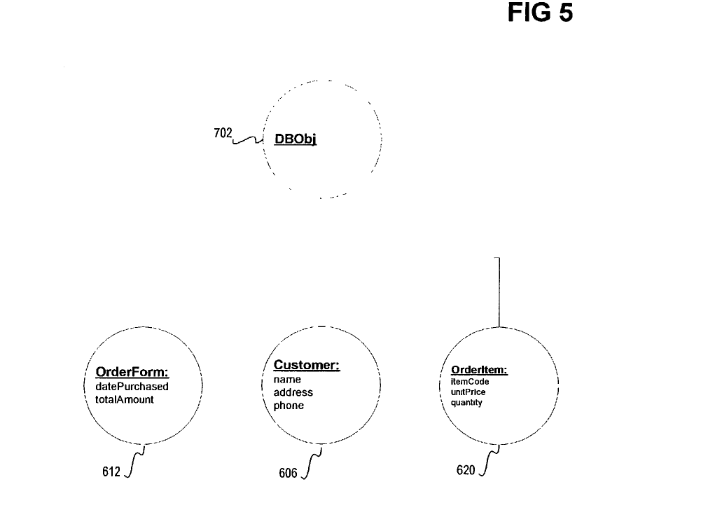

FIG. 5 shows an example of the hierarchy of the objects 606, 612, and 620 of FIG. 4 relative to the persistent base software object class 702, according to an embodiment of the invention. That is, FIG. 5 shows the object hierarchy of the example of FIG. 3, with the objects of FIG. 4. Each of the objects 606, 612, and 620 have object types derived from the persistent base class 702, DBObj. Thus, objects of this type can analyze themselves for persistence information, and generate corresponding calls to the relational database 604 of FIG. 4 when persistence functions, such as load, save, and delete, are invoked.

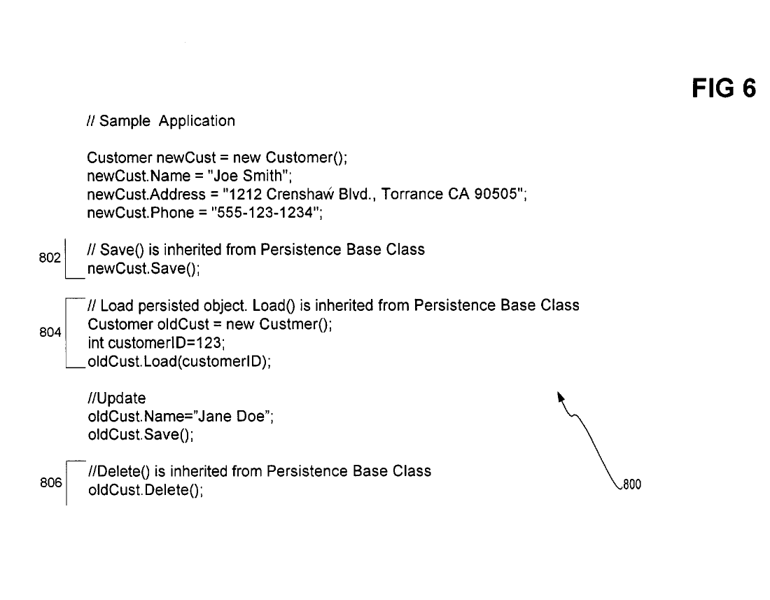

FIG. 6 shows an example of software code 800 that uses the domain objects that have been described, according to an embodiment of the invention. As can be appreciated by those of ordinary skill within the art, the software code 800 is for illustrative purposes only, and does not represent a limitation on the invention. That is, the invention itself is not limited to the software code 800. The software code 800 includes the portions 802, 804, and 806, among other software code portions.

The software code portion 802 shows how the method Save( ) of the class newCust is inherited from the persistence base class. Likewise, the software code portion 804 shows how the method Load( ) of the class oldCust is inherited from the persistence base class. Specifically, an object that has been persisted to the RDBMS is loaded. Finally, the software code portion 806 shows how the method Delete( ) of the class oldcust is inherited from the persistence base class.

It is noted that, although specific embodiments have been illustrated and described herein, it will be appreciated by those of ordinary skill in the art that any arrangement is calculated to achieve the same purpose may be substituted for the specific embodiments shown. This application is intended to cover any adaptations or variations of the present invention. Therefore, it is manifestly intended that this invention be limited only by the claims and equivalents thereof.

1. A method comprising:
deriving a software object class from a persistent base software object class that includes persistence functionality relative to relational database management systems (RDBMS), the software object class including the persistence functionality; and,
compiling the software object class to an executable software object having the persistence functionality built-in, such that the executable software object is able to persist to the RDBMS using the persistence functionality built-in.

2. The method of claim 1, further comprising executing the executable software object within a run-time environment having attribute and reflection properties.

3. The method of claim 1, wherein deriving the software object class from the persistent base software object class comprises adding relevant persistence attributes to source code for the software object class.

4. The method of claim 1, wherein compiling the software object class to the executable software object comprises compiling the software object class to an executable domain software object.

5. A system comprising:
a run-time environment having attribute and reflection properties;
a relational database management system (RDBMS); and,
one or more executable software objects having built-in functionality to persist themselves to the RDBMS and executed within the run-time environment.

6. The system of claim 5, further comprising a software object class from which the one or more executable software objects are compiled, the built-in functionality of the one or more executable software objects resulting from the compiling of the software object class thereto.

7. The system of claim 6, further comprising a persistent base software object class from which the software object class is derived and that includes persistence functionality relative to the RDBMS.

8. The system of claim 5, wherein the one or more executable software objects comprises one or more executable domain software objects.

9. A computer-readable medium having data stored thereon representing one or more executable software objects having persistence functionality built-in and executable within a run-time environment having attribute and reflection properties, such that the one or more executable software objects are able to persist themselves to a relational database management system (RDBMS).

10. The medium of claim 9, wherein the one or more executable software objects result from compiling a software object class thereto that includes the persistence functionality.

11. The medium of claim 10, wherein the software object class results from deriving a base software object class thereto that includes the persistence functionality relative to the RDBMS.

12. The medium of claim 9, wherein the medium is one or more of: a volatile medium, a non-volatile medium, a semiconductor memory, an optical medium, a hard disk drive, a floppy disk, a removable storage medium, a fixed storage medium, an optical medium, and a magnetic medium.

13. A computer-readable medium having data stored thereon representing a persistence library include a persistent base software object class that includes persistence functionality relative to a relational database management system (RDBMS) from which a software object class is derivable, the software object class compilable to an executable software object having the persistence functionality built-in, the executable software object executable within a runtime environment having attribute and reflection properties.

14. The medium of claim 13, wherein the persistence library comprises a dynamically linked library (DLL).

15. The medium of claim 13, wherein the medium is one or more of: a volatile medium, a non-volatile medium, a semiconductor memory, an optical medium, a hard disk drive, a floppy disk, a removable storage medium, a fixed storage medium, an optical medium, and a magnetic medium.
